(19) United States
(12) Patent Application Publication
(10) Pub. No.: US 2020/0000060 A1
(43) Pub. Date: Jan. 2, 2020

(54) CHEW TOY MADE OF SOLID RUBBER

(71) Applicant: James Scott Hayes, Penn Yan, NY (US)

(72) Inventor: James Scott Hayes, Penn Yan, NY (US)

(21) Appl. No.: 16/021,113

(22) Filed: Jun. 28, 2018

(51) Int. Cl. A01K 15/02

(52) U.S. Cl. CPC A01K 15/026

(57) ABSTRACT

A chew toy made of solid rubber, thereby making it virtually indestructible to a pet animal. The chew toy is dimensioned not to get caught in the throat of the pet animal.

### BACKGROUND OF THE INVENTION

The present invention relates to pet toys and, more particularly, to a pet chew toy made of lacrosse material rubber or other solid rubber, making the chew toy virtually indestructible to a chewing pet.

Pet chew toys serve useful purposes, including but not limited to helping clean the pet's teeth, strengthens their muscles, and releases endorphins. The other toys tear apart and are not safe to the chewing pets, as they may get lodged in the dog's throat. Bigger dogs, also, tend to destroy chew toys rather quickly as the currently used materials tend to fall apart, in part because they are hollow applications.

As can be seen, there is a need for a pet chew toy made of solid material rubber. The chew toy embodied in the present invention may be, in certain embodiments, a five-inch solid ball made of virtually indestructible solid rubber.

### SUMMARY OF THE INVENTION

In one aspect of the present invention, a chew toy adapted for a pet animal includes a shape formed from solid rubber virtually indestructible to the pet animal.

In another aspect of the present invention, chew toy adapted for a pet animal includes a five-inch, solid spheroid formed from solid rubber virtually indestructible to the pet animal, wherein the shape is dimensioned to not get lodged in the throat of the pet animal.

In yet another aspect of the present invention, a method of providing a chew toy for a predetermined pet animal includes dimensioning a mold for forming a solid spheroid wherein a diameter of the solid spheroid is dimensioned so that the solid spheroid cannot get caught in a throat of the pet animal.

In yet another aspect of the present invention the resulting cured solid rubber spheroid that is used as a chew toy may also help align vertebrae and/or soften muscle tissue under the guidance and instruction of a physical therapist and/or chiropractor.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a front elevational view of an exemplary embodiment of the present invention; and

FIG. 3 is a section view of an exemplary embodiment of the present invention, taken along line 3-3 in FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a chew toy made of solid rubber, thereby making it virtually indestructible to a pet animal. The chew toy is dimensioned not to get caught in the throat of the pet animal.

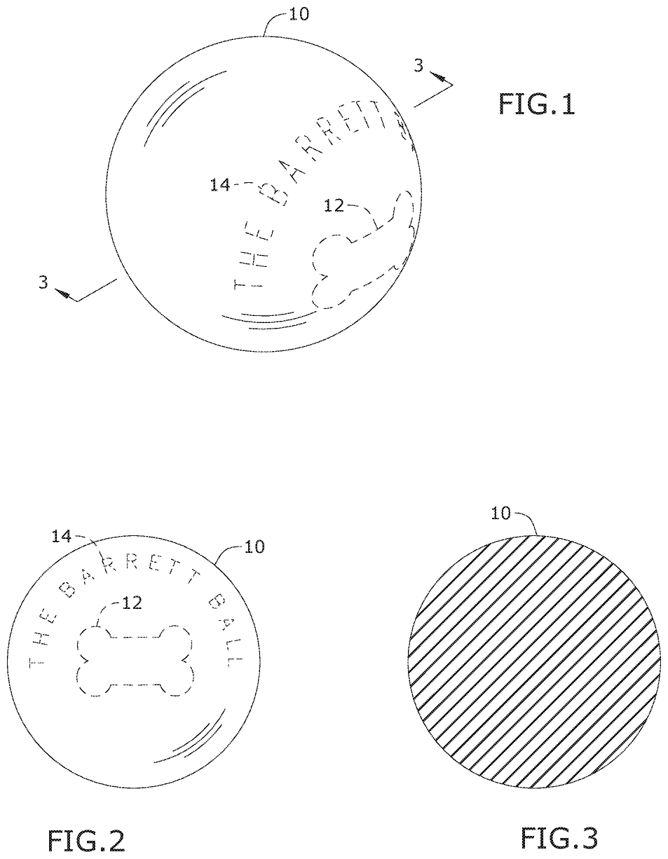

Referring to FIGS. 1 through 3, the present invention may include a chew toy 10 made from virtually indestructible non-toxic natural solid rubber. The chew toy 10 may be ball-shaped or the chew toy 10 may form any shape so long as the chew toy 10 functions in accordance with the present invention as described herein. A method of making the present invention may include forming the chew toy 10 from a solid mold. One would get a mold and natural rubber, then heat the rubber up and pour it in the mold, and then letting it cure. The natural rubber may be from the trees in Asia.

In certain embodiments, the chew toy 10 may be a five-inch diameter ball. In other embodiments, the chew toy may have stitching or other displayable medium, such as graphic printing, adhered to the peripheral surface of the chew toy 10 to display a logo 12 or textual content 14. In other embodiments, the chew toy 10 may be one or more colors, such as lime green.

A method of using the present invention includes the following. The chew toy 10 disclosed above may be provided. A user may give the chew toy 10 to a pet, such as a large or medium dog. The user need not worry about their pet choking as the chew toy 10 is dimensioned and adapted not to get caught in the pet's mouth. The chew toy 10 is virtually indestructible to dogs because the rubber is solid and not hollowed out.

Additionally, a rounded version of the chew toy 10 helps chiropractors align vertebrae and soften muscle tissue It can also be used for fitness for rolling on a user's back for yoga or the like.

It should be understood, of course, that the foregoing relates to exemplary embodiments of the invention and that modifications may be made without departing from the spirit and scope of the invention as set forth in the following claims.

What is claimed is:

1. A chew toy adapted for a pet animal, comprising:
a shape formed from solid rubber virtually indestructible to the pet animal.

2. The chew toy of claim 1, wherein the shape is a solid spheroid.

3. The chew toy of claim 1, wherein the shape is dimensioned to not get lodged in the throat of the pet animal.

4. The chew toy of claim 2, wherein the spheroid has a diameter of five inches.

5. The chew toy of claim 1, further comprising a displayed message along an outward-facing periphery of the shape.

6. The chew toy of claim 1, wherein the solid rubber has a lime green color.

7. A chew toy adapted for a pet animal, comprising:
a five-inch, solid spheroid formed from solid rubber virtually indestructible to the pet animal, wherein the shape is dimensioned to not get lodged in the throat of the pet animal.

8. A method of providing a chew toy for a predetermined pet animal, comprising:
dimensioning a mold for forming a solid spheroid wherein a diameter of the solid spheroid is dimensioned so that the solid spheroid cannot get caught in a throat of the pet animal.

9. A method of providing a chew toy for a predetermined pet animal that can be also be used by chiropractors for physical therapy of a human user, comprising:
providing the mold of claim 8;
urging natural rubber to fill the mold;
curing said natural rubber; and
instructing the human user to utilize the resulting cured solid rubber spheroid to help align vertebrae and/or soften muscle tissue.
